(19) United States
(12) Patent Application Publication
(10) Pub. No.: US 2024/0370751 A1
(43) Pub. Date: Nov. 7, 2024

(54) ESTIMATION APPARATUS, ESTIMATION METHOD, AND PROGRAM

(71) Applicant: NIPPON TELEGRAPH AND TELEPHONE CORPORATION, Tokyo (JP)

(72) Inventor: Yuka HASHIMOTO, Tokyo (JP)

(21) Appl. No.: 18/688,908

(22) PCT Filed: Sep. 7, 2021
(86) PCT No.: PCT/JP2021/032888

§ 371 Date: Mar. 4, 2024

(51) Int. Cl. G06N 7/08

(52) U.S. Cl. CPC G06N 7/08

(57) ABSTRACT

An estimation apparatus according to an embodiment includes an operator estimation unit configured to estimate a Koopman operator from time-series data composed of a plurality of elements by using the time-series data as an input, and a phase model estimation unit configured to estimate a phase model representing collective vibration of the plurality of elements and an interaction between the elements using the Koopman operator.

### TECHNICAL FIELD

The present invention relates to an estimation device (estimation apparatus), an estimation method, and a program.

### BACKGROUND ART

Regarding data composed of a plurality of elements, examining interactions between the elements is a problem that exists in common in various fields such as statistics, machine learning, physics, molecular dynamics, and the like. In physics, molecular dynamics, and the like, a method of describing information on collective vibration of a plurality of elements and interaction therebetween by a model called a phase model has been proposed (Non Patent Literature 1). In addition, a method of estimating a phase model from given data using a Fourier series or Hilbert transform has been proposed (Non Patent Literature 2). In the phase model, after data is converted into phase information by a function called a phase function, a relationship between phases is described by a function called a phase coupling function.

Here, in a case where there is one element, the phase model describes only the vibration of one element, but in this case, a method of estimating the phase model using a Koopman operator has been proposed (Non Patent Literature 3). The Koopman operator is a linear operator that describes time evolution of time-series data, and a method of estimating, from given time-series data, the Koopman operator to which the data conforms by using a Reproducing Kernel Hilbert Space (RKHS) or a generalization thereof, vvRKHS (Vector-Valued RKHS, Non Patent Literature 4) has been proposed (Non Patent Literature 5). Therefore, by using these methods, the phase model can be estimated from given data in a case where the number of elements is one.

### CITATION LIST

### Non Patent Literature

Non Patent Literature 1: H. Nakao, S. Yasui, M. Ota, K. Arai, and Y. Kawamura, “Phase reduction and synchronization of a network of coupled dynamical elements exhibiting collective oscillations,” Chaos 28, 045103 (2018).
Non Patent Literature 2: B. Kralemann, et al., “In vivo cardiac phase response curve elucidates human respiratory heart rate variability,” Nat. Commun. 4, 2418 (2013).
Non Patent Literature 3: S. Shirasaka, W. Kurebayashi, H. Nakao, “Phase-amplitude reduction of transient dynamics far from attractors for limit-cycling systems,” Chaos 27, 023119 (2017).
Non Patent Literature 4: H. Q. Minh, L. Bazzani, and V. Murino, “A unifying framework in vector-valued reproducing kernel Hilbert spaces for manifold regularization and co-regularized multi-view learning,” JMLR 17 (25), 1-72 (2016).
Non Patent Literature 5: Y. Hashimoto, I. Ishikawa, M. Ikeda, Y. Matsuo, and Y. Kawahara, “Krylov subspace method for nonlinear dynamical systems with random noise,” JMLR 21 (172), 1-29 (2020).

### SUMMARY OF INVENTION

### Technical Problem

It is difficult to estimate the entire phase function in the method of estimating the phase model using the Fourier series or the Hilbert transform, but it is possible to estimate the entire phase function in the method of estimating the phase model using the Koopman operator. However, the method of estimating the phase model using the Koopman operator requires only one element.

An embodiment of the present invention has been made in view of the above points, and an object of the present invention is to estimate a phase model for a plurality of elements using a Koopman operator.

### Solution to Problem

In order to achieve the above object, an estimation device (estimation apparatus) according to an embodiment includes an operator estimation unit configured to estimate a Koopman operator from time-series data composed of a plurality of elements by using the time-series data as an input, and a phase model estimation unit configured to estimate a phase model representing collective vibration of the plurality of elements and an interaction between the elements using the Koopman operator.

### Advantageous Effects of Invention

A phase model for a plurality of elements can be estimated using the Koopman operator.

### BRIEF DESCRIPTION OF DRAWINGS

FIG. 1 is a diagram illustrating an example of a hardware configuration of an estimation device according to the present embodiment.

FIG. 2 is a diagram illustrating an example of a functional configuration of the estimation device according to the present embodiment.

FIG. 3 is a flowchart illustrating an example of phase model estimation processing according to the present embodiment.

FIG. 4 is a diagram (1) illustrating an example of a scatter diagram in which eigenvalues of a Koopman operator are plotted on a complex plane.

FIG. 5 is a diagram illustrating an example of a phase function estimated from observation data.

FIG. 6 is a diagram illustrating an example of transformation calculated from an FHN model.

FIG. 7 is a diagram illustrating an example of a value of an antisymmetric portion of interaction.

FIG. 8 is a diagram (2) illustrating an example of a scatter diagram in which eigenvalues of the Koopman operator are plotted on a complex plane.

FIG. 9 is a diagram illustrating an example of a heat map indicating strength of interaction.

### DESCRIPTION OF EMBODIMENTS

An embodiment of the present invention will be described below. In the present embodiment, an estimation device 10 (estimation apparatus) capable of estimating a phase model for a plurality of elements using a Koopman operator will be described.

### <Theoretical Configuration>

First, a theoretical configuration when the estimation device 10 according to the present embodiment estimates a phase model for a plurality of elements using the Koopman operator will be described.

### <<1. Settings>>

Consider analyzing time-series data generated as follows.

$$[ Math . 1 ]$$

$$𝒳 = {ℝ}^{d} or [ 0.2 π )$$

The above formula is defined. Note that d is a predetermined natural number. Hereinafter, in the text of the specification, X (the calligraphic character X) shown in the above Math. 1 is written as “Xset”. In addition, in a case where there is no confusion with other symbols, blackboard bold characters (outline characters) are written as normal characters in the text of the specification (for example, the d-dimensional real space of the above Math. 1 is written as R^{d}.).

N elements described by a network (a network model of a coupled mechanical system) shown in the following Formula (1) denoted by X₁, . . . , X_{N}∈Xset.

$$[ Math . 2 ]$$

$$\frac{{dX}_{i} ( t )}{dt} = {F}_{\dot{t}} ( {X}_{i} ( t ) ) + {\sum }_{j = 1}^{N} {G}_{i , j} ( {X}_{i} ( t ) , {X}_{j} ( t ) ) \qquad ( 1 )$$

However, the initial value is Xᵢ(0)=x_{i,0}(i=1, . . . , N). Fᵢ represents the individual dynamics of an element Xᵢ, and G_{i,k} represents the influence of an element Xx on the element Xᵢ.

Here, X= [X₁, . . . , X_{N}]. It is assumed that data is generated at a constant time interval Δt, that is, time-series data of x_{i,1}=Xᵢ(Δt·1) is generated by the model represented by the above formula (1). Such time-series data is observable data and is also referred to as observation data. Note that 1 is a lower case L.

It is assumed that there is a common frequency ω that dominates the N elements and that each element weakly interacts with other elements. That is, it is assumed that the model represented by the above formula (1) is reduced to a phase model represented by the following formula (2).

$$[ Math . 3 ]$$

$$\frac{d {θ}_{i}}{dt} = ω + {Γ}_{i} ( {θ}_{i} - {θ}_{1} , … , {θ}_{i} - {θ}_{N} ) \qquad ( 2 )$$

Here, θ₁∈[0, 2π) represents a phase variable for Xᵢ, and Γᵢ represents an interaction between elements that affect the element Xᵢ. A function for transforming Xᵢ into θᵢ∈[0, 2π) is also referred to as a phase function, and Γᵢ is also referred to as a phase coupling function. In the present embodiment, estimating the phase function, the frequency ω, and the interaction Γᵢ only from observation data (that is, in a state where Fᵢ and G_{i,k} are not known) is considered.

### <<2. Estimation of Phase Model Using Koopman Operator>>

A Hilbert space composed of a function v from Xset^{N} to C^{N} (N-dimensional complex number space), where the i-th component of v(x)∈C^{N} depends only on the i-th component of x∈Xset^{N} is set to H. For example, vvRKHS generated from the following matrix value kernel function Φ:Xset^{N}×Xset^{N}→C^{N×N} can be set as H.

[Φ(x₁,x₂)]i,j=k((x_{1,i},i),(x_{2,j},j))

Here, k represents a complex-valued positive-definite kernel on the following formula,

$$[ Math . 4 ]$$

$${𝒳}^{N} \times ℕ$$

x_{1,i},i represents the i-th component of x₁∈Xset^{N}, and x_{2,j} represents the j-th component of x₂εXset^{N}. Refer to, for example, Non Patent Literature 4 for details of the configuration of vvRKHS.

For v∈H, the Koopman operator K on H is defined as a linear operator such that Kv(X(t))=v(X(t+Δt)) is satisfied. For a certain natural number 1 (1 is a lower case L), t₀=Δt·l. At this time, an optimization problem represented by the following formula (3) is conceived.

$$[ Math . 5 ]$$

$${min}_{λ , {α}_{i , k} ∈ ℂ , \vert λ \vert = 1 , u ( X ( {t}_{0} ) ) = 1} ‖ {λ}^{- 1} Ku - {\sum }_{i , k = 1}^{N} {a}_{i , k} {B}_{i , k} u ‖ \qquad ( 3 )$$

where B_{i,x} is a linear operator on H defined by B_{i,k}u=uₖeᵢ, uₖ is a k-th component of a vector value function u, and eᵢ is an N-dimensional vector in which only the i-th element is 1 and the other elements are 0. Note that the optimization problem represented by Formula (3) can be solved by, for example, a gradient method or the like.

According to certain ω∈[0,2π],

$$[ Math . 6 ]$$

$$λ = {e}^{\sqrt{- 1} Δ t ω}$$

it is assumed that the above formula is represented, and

$${e}^{\sqrt{- 1} Δ tj ω} ( j = 2 , … , M ) \qquad [ Math . 7 ]$$

it is assumed that N eigenvalues of the Koopman operator K which are close to the above formula are present for each j. Hereinafter, these eigenvalues are represented as λ_{j,i} (i=1, . . . , N). Note that M is a predetermined natural number of 2 or more.

It is assumed that there is an eigenvector for the eigenvalue λ_{j,i}, and this is represented as v_{j,i}. At this time, assuming that v_{j,1} (X (t₀)), . . . V_{j,N}(X(t₀)) is linearly independent for each j=2, . . . , M,

$${\sum }_{i = 1}^{N} {c}_{j , i} {v}_{j , i} ( X ( {t}_{0} ) ) = 1 \qquad [ Math . 8 ]$$

there exists c_{j,i}∈C that satisfies the above formula. However, 1 on the right side of the above formula 8 represents an N-dimensional vector in which all components are 1.

At this time, for j=2, . . . , M, an optimization problem Pⱼ represented by the following formula (4) is recursively considered.

$$\begin{matrix}[ Math . 9 ] & \\ {min}_{{a}_{i , k}^{j} ∈ ℂ} ‖ {e}^{- \sqrt{- 1} ωΔ t} {Ku}_{1} ⊙ … ⊙ {e}^{- \sqrt{- 1} j ωΔ t} {Ku}_{j} - ( {\sum }_{i , k = 1}^{N} {a}_{i , k}^{1} {B}_{i , k} {u}_{1} ) ⊙ … ⊙ ( {\sum }_{i , k = 1}^{N} {a}_{i , k}^{j} {B}_{i , k} {u}_{j} ) ‖ & ( 4 )\end{matrix}$$

where λ, a_{i,k}¹, and u¹ are the solutions to the optimization problem represented by the above formula (3), a_{i,k}^{l} is the solution to a minimization problem Pₗ with respect to l<j, and for l<j,

$${u}_{l} = {{\sum }_{i = 1}}^{N} {c}_{l , i} {v}_{l , i} \qquad [ Math . 10 ]$$

the above formula is defined. Note that l is a lower case L. Furthermore,

$$⊙ \qquad [ Math . 11 ]$$

represents a product for each component.

When the optimization problem Pⱼ represented by the above formula (4) is recursively solved until j=M, the following is obtained. Note that the optimization problem represented by the above formula (4) is a linear problem, and thus can be analytically solved.

$${\prod }_{j = 1}^{M} {u}_{i , j} ( {X}_{i} ( t + Δ t ) ) \approx {\prod }_{j = 1}^{M} ( {e}^{- \sqrt{- 1} j ω Δ t} {\sum }_{i , k = 1}^{N} {a}_{i , k}^{j} {B}_{i , k} {u}_{j} ) \qquad [ Math . 12 ]$$

where u_{i,j} is the i-th element of uⱼ.

Let θ_{i,j}(t)=arg(u_{i,j}(Xᵢ(t))), r_{i,j}(t)=|u_{i,j}(Xᵢ(t))|. According to the definition of uⱼ and Formula (4),

$${r}_{i , j} ( t ) \approx 1 \qquad [ Math . 13 ]$$

the above formula is defined. Therefore, the following is established.

$${\sum }_{j = 1}^{M} {θ}_{i , j} ( t + Δ t ) \approx {\sum }_{j = 1}^{M} ( j ωΔ t + {θ}_{i , j} ( t ) + arg ( {\sum }_{k = 1}^{N} {a}_{i , k}^{j} {e}^{- \sqrt{- 1} ( {θ}_{k , j} ( t ) - {θ}_{i , j} ( t ) )} ) ) \qquad [ Math . 14 ]$$

Further, since v_{i,j} is the eigenvector for the eigenvalue of the Koopman operator K represented by the following formula,

$${λ}_{j , i} \approx {e}^{\sqrt{- 1} Δ tj ω} \qquad [ Math . 15 ]$$

according to the definition of uⱼ,

$${u}_{i , j} ( X ( t + Δ t ) ) \approx {e}^{\sqrt{- 1} Δ tj ω} {u}_{i , j} ( X ( t ) ) \qquad [ Math . 16 ]$$

the above formula is defined. Accordingly,

$${θ}_{i , j} ( t + Δ t ) \approx Δ tj ω + {θ}_{i , j} ( t ) \qquad [ Math . 17 ]$$

the above formula is defined, and thus when θ_{i,j}(t) is approximated by jθ_{i,1}(t), the following formula (5) is established.

$$\begin{matrix}[ Math . 18 ] & \\ {θ}_{i , 1} ( t + Δ t ) \approx ω Δ t + {θ}_{i , 1} ( t ) + {\sum }_{j = 1}^{M} arg ( {\sum }_{k = 1}^{N} {a}_{i , k}^{j} {e}^{- \sqrt{- 1} j ( {θ}_{k , 1} ( t ) - {θ}_{i , 1} ( t ) )} ) & ( 5 )\end{matrix}$$

Therefore, in the above formula (5),

$${θ}_{i} = {θ}_{i , 1} \\ {ψ}_{k} = {θ}_{k , 1} - {θ}_{i , 1} \\ {Γ}_{i} ( {ψ}_{1} , … , {ψ}_{N} ) = \frac{1}{Δ t} {\sum }_{j = 1}^{M} arg ( {\sum }_{k = 1}^{N} {a}_{i , k}^{j} {e}^{- \sqrt{- 1} j {ψ}_{k}} ) \qquad [ Math . 19 ]$$

when the above formulae are defined, the above formula (2) is obtained. Note that θ_{i,1}(t)=arg(u_{i,1}(Xᵢ(t))) is a phase function.

### <<3. Estimation of Koopman Operator>>

If the Koopman operator K can be estimated from observation data, a phase model to which the observation data conforms can be estimated by the method described in “2. Estimation of Phase Model using Koopman Operator”. For example, the method described in Non Patent Literature 5 may be used as a method of estimating the Koopman operator K from the observation data.

### <Hardware Configuration of Estimation Device 10>

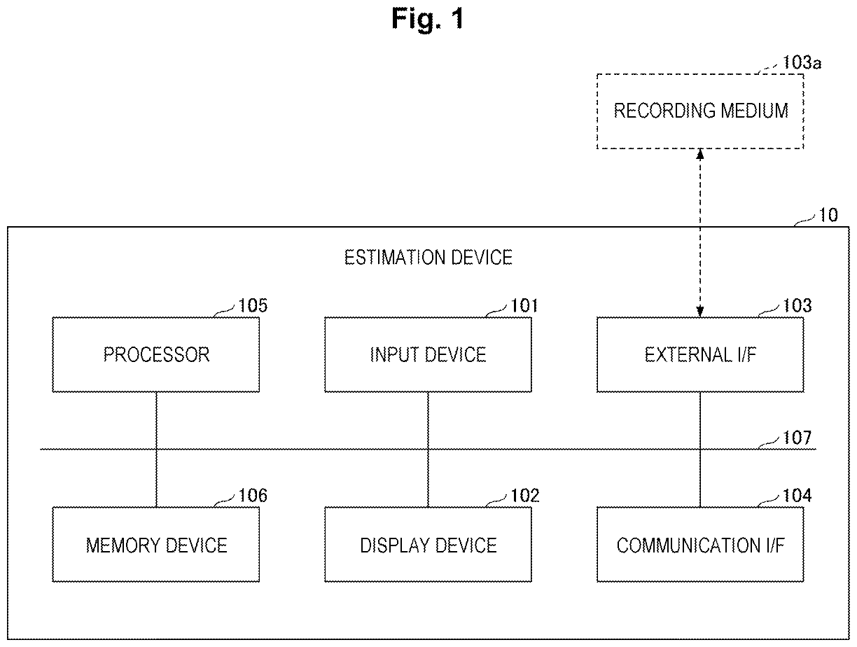

Next, a hardware configuration of the estimation device 10 according to the present embodiment will be described with reference to FIG. 1. As illustrated in FIG. 1, the estimation device 10 according to the present embodiment is implemented by a hardware configuration of a general computer or computer system, and includes an input device 101, a display device 102, an external I/F 103, a communication I/F 104, a processor 105, and a memory device 106. These pieces of hardware are connected to each other via a bus 107 such that they can communicate.

The input device 101 is, for example, a keyboard, a mouse, a touch panel, a physical button of various types, or the like. The display device 102 is, for example, a display, a display panel, or the like. Note that the estimation device 10 may not include, for example, at least one of the input device 101 and the display device 102.

The external I/F 103 is an interface with an external device such as a recording medium 103a. The estimation device 10 can perform reading/writing from/to the recording medium 103a via the external I/F 103. Note that examples of the recording medium 103a include, for example, a compact disc (CD), a digital versatile disk (DVD), a secure digital (SD) memory card, and a Universal Serial Bus (USB) memory card.

The communication I/F 104 is an interface for connecting the estimation device 10 to a communication network. The processor 105 is, for example, one of various arithmetic devices such as a central processing unit (CPU) and a graphics processing unit (GPU). The memory device 106 is one of various storage devices such as a hard disk drive (HDD), a solid state drive (SSD), a flash memory, a random access memory (RAM), and a read only memory (ROM).

Since the estimation device 10 according to the present embodiment has the hardware configuration illustrated in FIG. 1, it is possible to realize various types of processing which will be described later. Note that the hardware configuration illustrated in FIG. 1 is an example, and the estimation device 10 may include, for example, a plurality of processors 105, a plurality of memory devices 106, or various types of hardware other than the illustrated hardware.

### <Functional Configuration of Estimation Device 10>

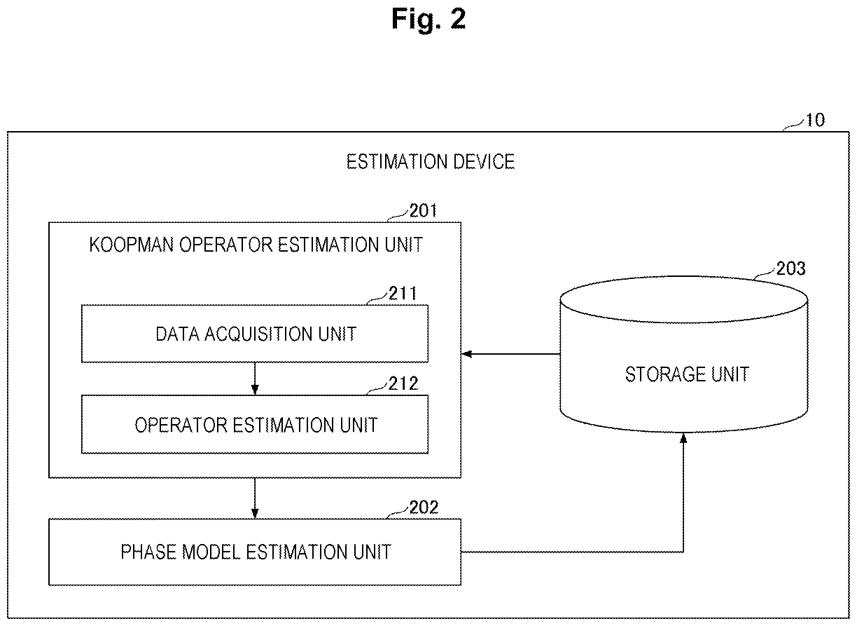

Next, a functional configuration of the estimation device 10 according to the present embodiment will be described with reference to FIG. 2. As illustrated in FIG. 2, the estimation device 10 according to the present embodiment includes a Koopman operator estimation unit 201, a phase model estimation unit 202, and a storage unit 203. The Koopman operator estimation unit 201 and the phase model estimation unit 202 are realized, for example, by the processor 105 executing processing using one or more programs installed in the estimation device 10. Further, the storage unit 203 is realized by, for example, the memory device 106. Note that the storage unit 203 may be realized by, for example, a storage device (for example, a database server or the like) connected to the estimation device 10 via a communication network.

The Koopman operator estimation unit 201 estimates the Koopman operator K from observation data. Here, the Koopman operator estimation unit 201 includes a data acquisition unit 211 and an operator estimation unit 212. The data acquisition unit 211 acquires observation data from the storage unit 203. The operator estimation unit 212 estimates the Koopman operator K from the observation data acquired by the data acquisition unit 211 using, for example, the method described in Non Patent Literature 5.

The phase model estimation unit 202 estimates a phase model to which the observation data conforms by the method described in “2. Estimation of Phase Model using Koopman Operator” using the Koopman operator K estimated by the Koopman operator estimation unit 201.

The storage unit 203 stores observation data. Note that the storage unit 203 may store the phase model (phase function, frequency ω, and interaction Γᵢ) estimated by the phase model estimation unit 202.

### <Phase Model Estimation Processing>

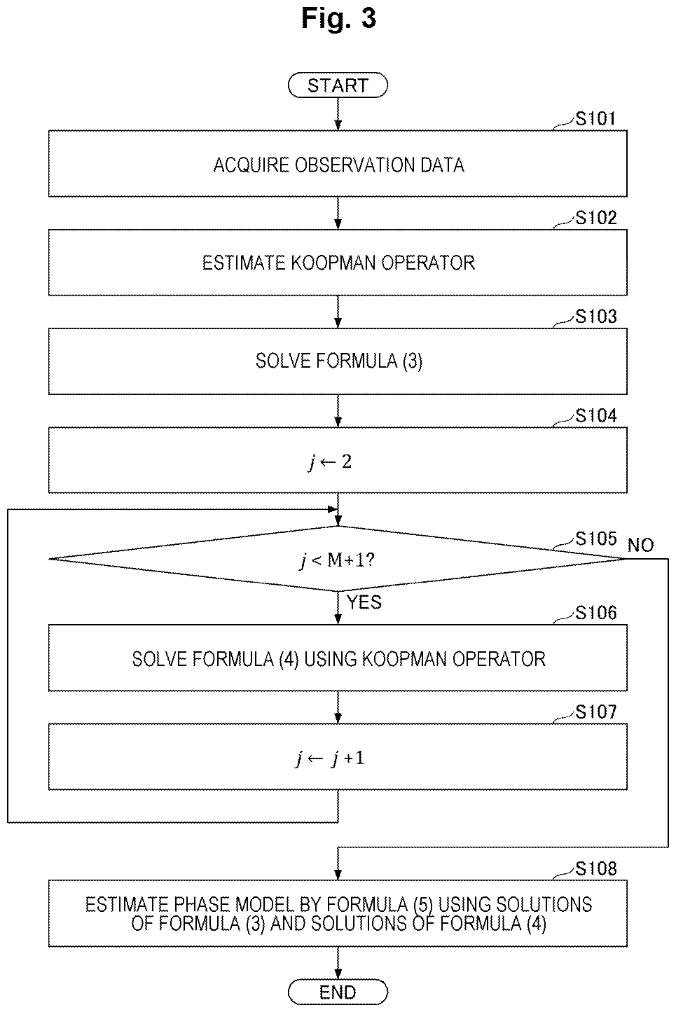

Next, phase model estimation processing according to the present embodiment will be described with reference to FIG. 3.

The data acquisition unit 211 of the Koopman operator estimation unit 201 acquires observation data from the storage unit 203 (step S101).

The operator estimation unit 212 of the Koopman operator estimation unit 201 estimates the Koopman operator K from the observation data acquired in step S101 described above (step S102). Note that, as described above, the operator estimation unit 212 may estimate the Koopman operator K from the observation data using, for example, the method described in Non Patent Literature 5.

The phase model estimation unit 202 solves the optimization problem represented by the above formula (3) using the Koopman operator K estimated in the above step S102 (step S103). Note that the phase model estimation unit 202 can solve the optimization problem represented by the above formula (3) using, for example, a gradient method or the like.

The phase model estimation unit 202 sets j←2 (step S104).

The phase model estimation unit 202 determines whether or not j<M+1 is satisfied (step S105). Note that M is a predetermined natural number of 2 or more.

If it is determined in step S105 described above that j<M+1 is satisfied, the phase model estimation unit 202 solves the optimization problem represented by the above formula (4) using the Koopman operator K estimated in step S102 described above (step S106). Note that, since the optimization problem represented by the above formula (4) is a linear problem, the phase model estimation unit 202 can analytically solve the optimization problem represented by the formula (4).

The phase model estimation unit 202 sets j←j+1 (step S107), and returns to step S105 described above. As a result, for j=2, . . . , M, the optimization problem represented by the above formula (4) is recursively solved.

If it is not determined in step S105 described above that j<M+1 is satisfied, the phase model estimation unit 202 estimates the phase model by the above formula (5) using the solutions of the optimization problem represented by the above formula (3) and the solutions of the optimization problem represented by the above formula (4) (step S108). As a result, the phase model to which the observation data acquired in step S101 conforms is estimated.

### <Evaluation>

Hereinafter, evaluation of the phase model estimated by the estimation device 10 according to the present embodiment will be described.

### <<Estimation of Phase Function and Phase Coupling Function>>

10 pieces of time-series data (observation data) x₀ⁱ, . . . , x₂₀₀₀ⁱ (i=1, . . . , 10) were generated by changing an initial value from a FitzHugh-Nagumo (FHN) model on Xset=R², the Koopman operator K was estimated, and then, a phase function ηⁱ(ηⁱ(x)=arg(u_{i,1}(x)), ×∈R²) representing a transformation from Xᵢ(t) to θᵢ(t) and the interaction Γᵢ(ψₗ, . . . , ψ_{N}) in the above formula (5) were calculated by the method described in “2. Estimation of Phase Model using Koopman Operator”.

The FHN model is obtained by setting Fₗ(Xᵢ)=F(Xᵢ)=[yᵢ(yᵢ−c)(1−yᵢ)−zᵢ, μ^{-l}(yᵢ−dzᵢ)], G_{i,j}(Xᵢ, Xⱼ)=G(Xᵢ, Xⱼ)=[0.01(zᵢ−zⱼ), 0], c=−0.1, d=0.5, and μ=100 for Xᵢ(t)=[yᵢ(t), zᵢ(t)]∈R² in the network represented by the above formula (1).

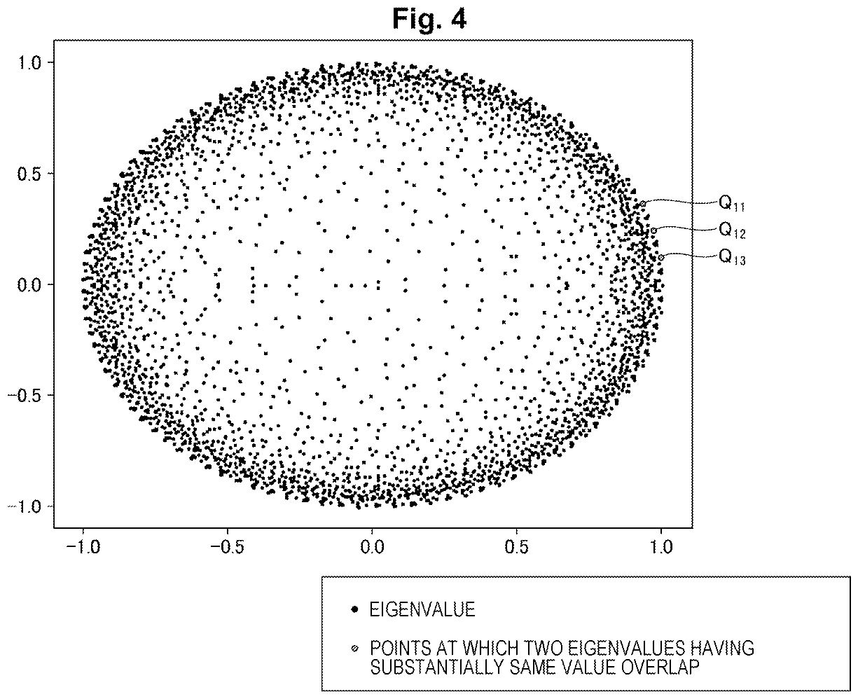

At this time, a scatter diagram in which the eigenvalues of the Koopman operator K estimated by the Koopman operator estimation unit 201 are plotted on a complex plane is shown in FIG. 4. The horizontal axis represents the real part, and the vertical axis represents the imaginary part.

As illustrated in FIG. 4, there are three points (Q₁₁, Q₁₂, and Q₁₃) at which two eigenvalues having substantially the same value overlap. Two eigenvalues present at the position (Q₁₃) closest to 1 among these three positions are set as λ_{l,l} and λ_{l,2}. In addition, an eigenvector for the eigenvalue λ_{1,1} is set as v_{1,1}, and an eigenvector for the eigenvalue λ_{1,2} is set as v_{l,2}. At this time, with s=1899, for c_{1,1}, c_{l,2}∈C satisfying c_{l,l}Σᵢ₌₁¹⁰v_{1,1}(xₛⁱ)/10+c_{l,2}Σᵢ₌₁¹⁰v_{1,2}(xₛⁱ)/10=1, u₁⁰=C_{1,1}V_{1,1}+C_{1,2}V_{1,2} is set, and the optimization problem represented by the above formula (3) is solved with λ=λ_{1,1}, u=uₗ⁰, a_{l,2}=a_{2,l=}0.002, and a_{1,1}=a_{2,2=}0 as initial values. Further, M=3 is set, eigenvalues present at points other than the points at which λ_{1,1} and λ_{1,2} are present are set as λ_{2,i}(i=1, 2) and λ_{3,i}(i=1, 2), respectively, among the points at which two eigenvalues having substantially the same value overlap, and the optimization problem represented by the above formula (4) is solved.

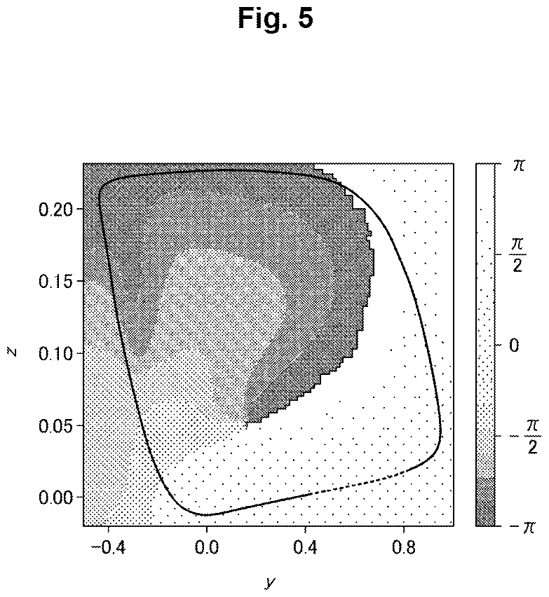

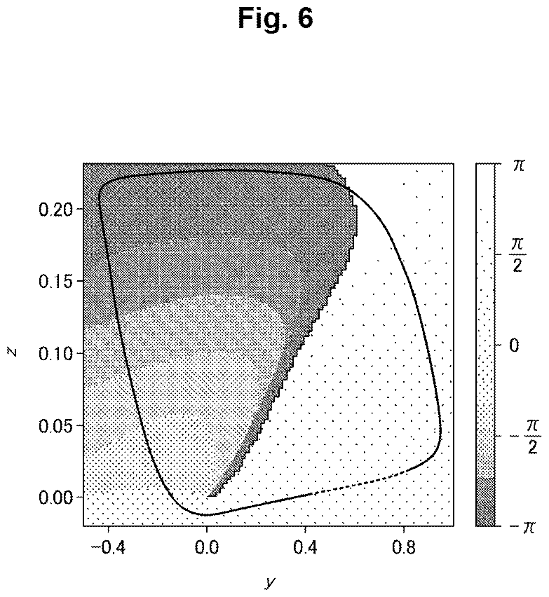

In this example, since N=2, and Fᵢ=F₂ and G_{1,2}=G_{2,l} in the above formula (1), η₁=η₂ should be satisfied. Therefore, only η₁ is calculated by the phase model estimation unit 202. The results are illustrated in FIG. 5. On the other hand, FIG. 6 illustrates results of directly calculating the transformation from Xᵢ(t) to θᵢ(t) from the FHN model. It can be ascertained from comparison between FIG. 5 and FIG. 6 that the results (FIG. 5) estimated from the observation data are close to the results (FIG. 6) directly calculated from the FHN model.

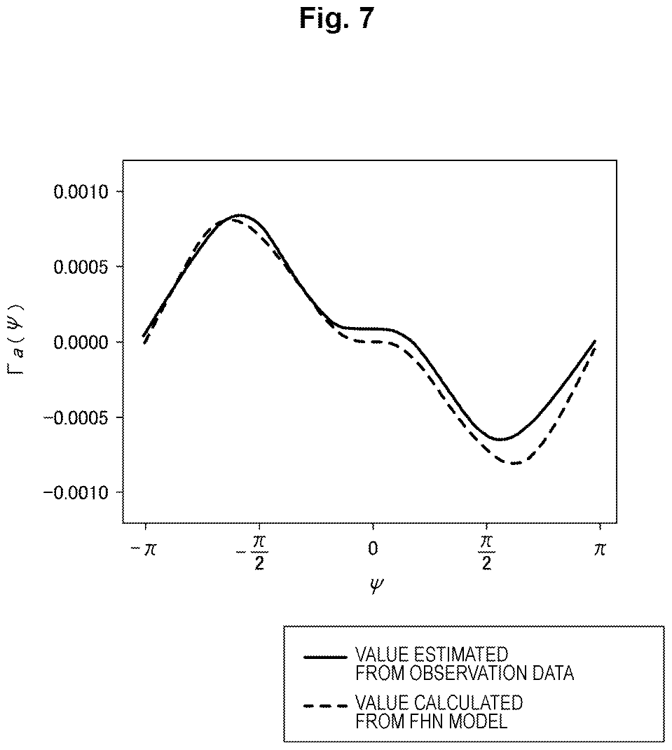

In addition, FIG. 7 illustrates results of calculating the antisymmetric portion Γ_{α}(ψ)=Γₗ(ψ)−Γ₂(−ψ) of the interaction Γᵢ. In this regard, as illustrated in FIG. 7, it can be ascertained that a value estimated from the observation data is close to a value directly calculated from the FHN model.

### <<Estimation of Strength of Interaction>>

10 pieces of time-series data (observation data) x₀ⁱ, . . . , X₂₀₀₀ⁱ (i=1, . . . , 10) were generated by changing an initial value from an SL model on Xset=R², the Koopman operator K was estimated, and then the optimization problem represented by the above formula (3) was solved and a_{i,k} representing the strength of interaction was estimated.

The SL model is obtained by setting Fₗ(Xᵢ)=F(Xᵢ)=[yᵢ−azᵢ−(yᵢ²+zᵢ²) (byᵢ+zᵢ), zᵢ−(yᵢ²+zᵢ²) (byᵢ+zᵢ)], G(Xᵢ, Xⱼ)=[0.01(zⱼ−zᵢ), 0], G_{1,2}(Xᵢ, Xⱼ)=G_{2,1}(Xᵢ, Xⱼ)=G (Xᵢ, Xⱼ), a=2, and b=1 for Xᵢ(t)=[yᵢ(t), zᵢ(t)]∈R² in the network represented by the above formula (1).

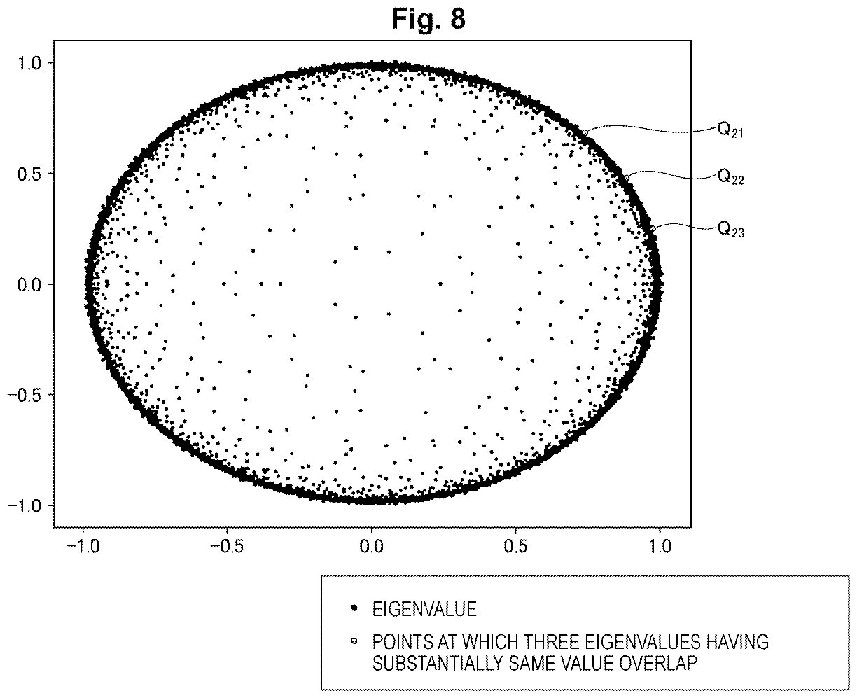

At this time, a scatter diagram in which the eigenvalues of the Koopman operator K estimated by the Koopman operator estimation unit 201 are plotted on a complex plane is shown in FIG. 8. The horizontal axis represents the real part, and the vertical axis represents the imaginary part.

As illustrated in FIG. 8, there are three points (Q₂₁, Q₂₂, and Q₂₃) at which three eigenvalues having substantially the same value overlap. The eigenvalues present at these three points Q₂₁, Q₂₂, and Q₂₃ are set as λ₁, λ₂, and λ₃, respectively. In addition, an eigenvector for the eigenvalue λₗ is set as v₁, an eigenvector for the eigenvalue λ₂ is set as v₂, and an eigenvector for the eigenvalue λ₃ is set as v₃. At this time, with s=1899, for c₁, c₂, and c₃∈C satisfying cₗ∈ᵢ₌₁¹⁰v₁(xₛⁱ)/10+c₃∈ᵢ₌₁¹⁰v₂ (xₛⁱ)/10+C₃∈ᵢ₌₁¹⁰v₃(xₛⁱ)/10=1, uₗ⁰=c₁vₗ+C₂v₂+c₃v₃ is set.

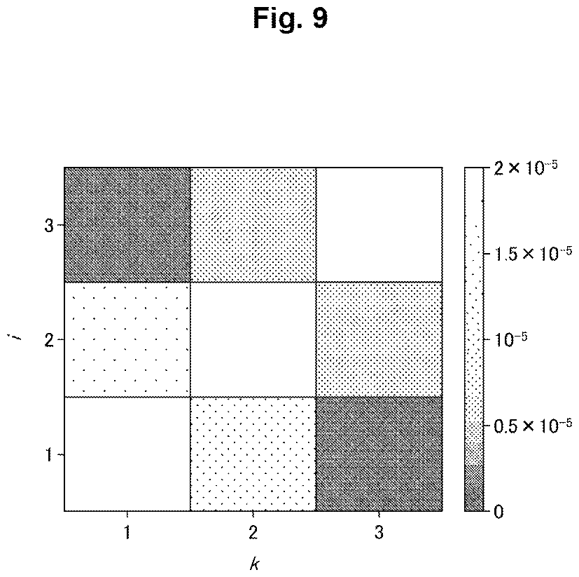

In this example, since the purpose is only to obtain the size of a_{i,k}, λ=λ₁, and u=u₁⁰ are fixed in the above formula (3), and the optimization problem represented by the formula (3) is solved as a linear problem. FIG. 9 illustrates a heat map indicating the size of a_{i,k} obtained as a result. As illustrated in FIG. 9, it is estimated that interaction between the element X₁ and the element X₂ is large, which is a result reflecting that the interaction between the element X₁ and the element X₂ is large in the original model (SL model).

### <Conclusion>

As described above, the estimation device 10 according to the present embodiment can accurately estimate a phase model for a plurality of elements using the Koopman operator. Therefore, it is possible to perform analysis such as extracting an interaction between a plurality of elements with respect to data including the elements using the phase model estimated by the estimation device 10 according to the present embodiment. Note that the estimation device 10 according to the present embodiment may perform the above analysis using, for example, the estimated phase model, or may control a system (alternatively, equipment or the like constituting the system) represented by a network model of a coupled dynamic system using the analysis result.

The present invention is not limited to the above-mentioned specifically disclosed embodiment, and various modifications and changes, combinations with known technology, and the like can be made without departing from the scope of the claims.

### REFERENCE SIGNS LIST

10 Estimation device
101 Input device
102 Display device
103 External I/F
103a Recording medium
104 Communication I/F
105 Processor
106 Memory device
107 Bus
201 Koopman operator estimation unit
202 Phase model estimation unit
203 Storage unit
211 Data acquisition unit
212 Operator estimation unit

1. An estimation apparatus comprising:
a processor; and
a memory that includes instructions, which when executed, cause the processor to execute:
estimating a Koopman operator from time-series data composed of a plurality of elements by using the time-series data as an input; and
estimating a phase model representing collective vibration of the plurality of elements and an interaction between the elements using the Koopman operator.

2. The estimation apparatus according to claim 1, wherein the estimating of the phase model includes
solving a first optimization problem by a gradient method using the Koopman operator;
recursively solving a second optimization problem a predetermined number of times using solutions of the first optimization problem and the Koopman operator; and
estimating the phase model using the solutions of the first optimization problem and solutions of the second optimization problem.

3. The estimation apparatus according to claim 2, wherein the first optimization problem is represented by the following formula,
$${min}_{λ , {a}_{i , k} ∈ ℂ , \vert λ \vert = 1 , u ( X ( {t}_{0} ) ) = 1} ‖ {λ}^{- 1} Ku - {\sum }_{i , k = 1}^{N} {a}_{i , k} {B}_{i , k} u ‖ \qquad [ Math . 20 ]$$
on the assumption that the time-series data is X(t)=[Xₗ(t), . . . , X_{N}(t)], the Koopman operator is K, and a linear operator in a Hilbert space defined by B_{i,k}u=uₖeᵢ is B_{i,k} uₖ is a k-th component of a vector value function u, eᵢ is an N-dimensional vector in which only an i-th element is 1 and other elements are 0, and a certain t is t₀.

4. The estimation apparatus according to claim 3, wherein
the second optimization problem is represented by the following formula,
$${min}_{{a}_{i , k}^{j} ∈ ℂ} ‖ {e}^{- \sqrt{- 1} ωΔ t} {Ku}_{1} ⊙ … ⊙ {e}^{- \sqrt{- 1} j ωΔ t} {Ku}_{j} - ( {\sum }_{i , k = 1}^{N} {a}_{i , k}^{1} {B}_{i , k} {u}_{1} ) ⊙ … ⊙ ( {\sum }_{i , k = 1}^{N} {a}_{i , k}^{j} {B}_{i , k} {u}_{j} ) ‖ \qquad [ Math . 21 ]$$
on the assumption that a data interval of the time-series data is Δt, a certain frequency is ω∈[0, 2π], the solutions of the first optimization problem are λ=e\hat{ }((√(−1))Δtω), a_{i,k}¹, and u¹, and an eigenvalue of the Koopman operator K is λ_{j,i}=e\hat{ }((√(−1)Δtjω) (where j=2, . . . , M, i=1, . . . , N, and M is a predetermined integer of 2 or more), and
the phase model estimation unit recursively solves the second optimization problem for j=2 . . . , M.

5. The estimation apparatus according to claim 4, wherein the estimating of the phase model includes estimating the phase model configured by the frequency ω and a phase coupling function by approximating the phase coupling function using the solutions λ, a_{i,k}¹, and u¹ of the first optimization problem and the solutions a_{i,k}², . . . , a_{i,k}^{M} of the second optimization problem.

6. An estimation method, executed by a computer, comprising:
estimating a Koopman operator from time-series data composed of a plurality of elements by using the time-series data as an input; and
estimating a phase model representing collective vibration of the plurality of elements and an interaction between the elements using the Koopman operator.

7. A non-transitory computer-readable recording medium having computer-readable instructions stored thereon, which when executed, cause a computer including a memory and a processor to execute the estimation method according to claim 6.
